(19) United States
(12) Patent Application Publication
(10) Pub. No.: US 2007/0121935 A1
(43) Pub. Date: May 31, 2007

(54) Method for countermeasuring in an electronic component

(75) Inventor: Marc Joye, Saint Zacharie (FR)

Correspondence Address: BUCHANAN, INGERSOLL & ROONEY PC, POST OFFICE BOX 1404, ALEXANDRIA, VA, 22313-1404, US

(73) Assignee: GEMPLUS, Gémenos (FR)

(21) Appl. No.: 10/561,276

(22) PCT Filed: Jun. 17, 2004
(86) PCT No.: PCT/EP04/51142

§ 371 Date: Jul. 17, 2006

(30) Foreign Application Priority Data
Jun. 18, 2003 (FR) 0307380

(51) Int. Cl. H04L 9/30

(52) U.S. Cl. 380/30

(57) ABSTRACT

The invention relates to a method for countermeasuring in an electronic component while using a public key cryptographic algorithm. The invention involves the use of a public key cryptographic algorithm containing an exponentiation calculation y=gˆd, in which g and y are elements of specified group G noted in a multiplicative manner and d is a predetermined number.

The present invention relates to a method for countermeasuring in an electronic component implementing a secret-key encryption algorithm.

In the conventional secret-key cryptography model, two people who wish to communicate over a non-secure channel must first agree on a secret encryption key K. The encryption function and the decryption function use the same key K. The drawback of the public-key encryption system is that said system requires prior communication of the secret key between the two people over a secure channel, before any encrypted message is sent over a non-secure channel. In practice, it is generally difficult to find a communications channel that is fully secure, especially if the two people are a long distance apart. The term “secure channel” is used to mean a channel for which it is impossible to know or to modify the information conveyed over said channel. Such a secure channel can be implemented by a cable interconnecting two terminals possessed by respective ones of said two people.

The concept of public-key cryptography was invented by Whitfield Diffie and Martin Hellman in 1976 (IEEE Transactions on Information Theory, volume 22, number 6, pages 644-654, 1976). Public-key cryptography makes it possible to solve the problem of distributing keys over a non-secure channel. The principle of public-key cryptography consists in using a pair of keys, namely an encryption public key and a decryption private key. It must be computationally unfeasible to find the decryption private key from the encryption public key. A person A wishing to communicate information to a person B uses the encryption public key of the person B. Only the person B possesses the private key associated with his or her public key. Therefore, only the person B is capable of decrypting the message sent to him or her.

The difficult computational problem considered by Diffie and Hellman is to solve the discrete logarithm problem in the multiplicative group of a finite field.

It is recalled that, in a finite field, the number of elements of the field is always expressed in the form qˆn, where q is a prime number that is called the “characteristic” of the field and n is an integer number. A finite field possessing qˆn elements is written GF(qˆn). When the integer number n is equal to 1, the finite field is said to be “prime”. A field has two groups, namely a multiplicative group and an additive group. In the multiplicative group, the neutral element is written “1” and the group law is written in multiplicative notation by the symbol “.” and is called “multiplication”. Said law defines the exponentiation operation in the multiplicative group G: given that an element g belonging to G is an integer d, the result of the exponentiation of g by d is the element y such that y=g^{d}=g·g·g . . . ·g (d times) in the group G. It is also recalled that the order of a group G is the number of its elements and that the order of an element g in G is the most integer positive e such that gˆe=1 in G. An important property on the order of the elements of a group is given by Lagrange's theorem: the order of any element always divides the order of its group.

Solving the discrete logarithm problem in the multiplicative group G of a finite field consists in determining whether there exists an integer d such that y=gˆd in G, given two elements y and g belonging to G.

Another advantage of public-key cryptography over secret-key cryptography is that public-key cryptography makes authentication possible by using an electronic signature.

The first implementation of a public-key encryption scheme was developed in 1977 by Ronald Rivest, Adi Shamir, and Leonard Adleman (Communications of the ACM, volume 21, number 2, pages 120-126, 1978) who invented the RSA (Rivest-Shamir-Adleman) encryption system. The security of RSA is based on the difficulty of factoring a large number which is the product of two prime numbers.

The RSA encryption system is built in the multiplicative group G of the ring Z/(nZ) obtained by taking the quotient of the ring of the integers Z by the ring nZ, where n is a large integer which is the product of prime numbers p and q. Solving the RSA problem in said group G consists in determining whether there exists an element m of G such that c=mˆe in G, given an element c of G and an integer e relatively prime with the order of the Group G.

Since then, numerous public-key encryption systems have been proposed, the security of such systems being based on various computation problems, a non-exhaustive list of which is given below:
Merkle-Hellman knapsack:
   That encryption system is based on the difficulty of the subset sum problem.
McEliece:
   That encryption system is based on the algebraic code theory. It is based on the linear code decoding problem.
El Gamal:
   That encryption system is based on the difficulty of the discrete logarithm problem in a finite field.
Elliptic curves:
   The elliptic-curve encryption system constitutes a modification to existing cryptographic systems so as to apply them to the domain of elliptical curves.

The use of elliptic curves in cryptographic systems was proposed independently by Victor Miller (Advances in Cryptology—CRYPTO '85, volume 216 of Lecture Notes in Computer Science, Springer-Verlag, 1986) and Neal Koblitz (Mathematics of Computation, volume 48, number 177, pages 203-209, 1987) in 1985. The real applications of elliptic curves were devised at the beginning of the nineteen nineties. The advantage of cryptographic systems based on elliptic curves is that they provide security equivalent to the other cryptographic systems but with smaller key sizes. That saving in key size brings a reduction in memory needs and a reduction in computation time, thereby making the use of elliptic curves particularly well suited to applications of the smart card type.

It is recalled that an elliptic curve on a finite field GF(qˆn) is the set of firstly the points (x,y) belonging to GF(qˆn) verifying the following equation: Yˆ2+a₁xy+a₃y=xˆ3+a₂xˆ2+a₄x+a₆, with a₁ in GF(qˆn), and secondly the point at infinity 0. Any elliptic curve defined on a field can be expressed in this form.

The set of the points (x,y) and the point at infinity form an abelian group in which the point at infinity is the neutral element and in which the group operation is points addition, noted “+” and given by the well known rule of the secant and of the tangent (see, for example, “Elliptic Curve Public Key Cryptosystems” by Alfred Menezes, Kluwer, 1993). In that group, the (x,y) pair, where the x-axis and the y-axis are elements of the field GF(qˆn), forms the affine co-ordinates of a point P of the elliptic curve.

The points addition operation makes it possible to define an elliptic curve exponentiation operation: given a point P belonging to an elliptic curve, and an integer d, the result of the exponentiation of P by d is the point Q such that Q=d*P=P+P+ . . . +P (d times). When elliptic curves are used, in order to emphasize the additive notation, the exponentiation is also called “scalar multiplication”.

The security of elliptic-curve cryptographic algorithms is based on the difficulty of the discrete logarithm problem in Group G formed by the points of an elliptic curve, said problem consisting, from points Q and P belonging to G, in finding an integer d such that Q=d*P, when such an integer exists.

Numerous cryptography algorithms exist that are built on a group G. Thus, it is possible to implement algorithms providing authentication, confidentiality, integrity checking, and key exchange.

A property common to most cryptography algorithms built on a group G is that they have, as a parameter, an element g belonging to that group. The private key is an integer d that is chosen randomly. The public key is an element such that y=gˆd. Such cryptography algorithms generally involve an exponentiation in computing an element z=hˆd, where d is the secret key and h is an element of the group G.

In the paragraph below, a description is given of an encryption algorithm based on the discrete logarithm problem in a group G, written in multiplicative notation. That scheme is analogous to the El Gamel encryption scheme. Let a group be G and an element in G be g. The encryption public key is y=gˆd and the decryption private key is d. A message m is encrypted in the following manner:
The person who wishes to communicate information, that person being referred to as the “encrypter”, chooses an integer k randomly and computes the elements h=gˆk and z=yˆk in the Group G, and c=R(z)⊕m, where R is a function applying the elements of G to all of the messages and ⊕ designates the exclusive OR operator. The ciphertext corresponding to m is the pair (h,c).
The person to whom the ciphertext is addressed, referred to as the “decrypter”, who possesses the secret key d, decrypts m by computing:
   z′=hˆd=gˆ(k·d)=yˆk and m=R(z′)⊕c.

In order to perform the exponentiations necessary in the above-described computation methods, several algorithms exist:
the left-to-right binary exponentiation algorithm;
the addition chain exponentiation algorithm or the addition-subtraction chain exponentiation algorithm;
the left-to-right k-ary exponentiation algorithm; and
the algorithm for exponentiation with signed-digit representation of the exponent.

Those algorithms are described in detail in Chapter 14 of the “Handbook of Applied Cryptography” by A. J. Menezes, P. C. van Oorschot, and S. A. Vanstone, CRC Press, 1997. This list is not exhaustive.

The simplest and most commonly used algorithm is the left-to-right binary exponentiation algorithm. The left-to-right binary exponentiation algorithm takes as input an element g of a group G and an exponent d. The exponent d is written d d=(d(t),d(t−1), . . . , d(0)), where (d(t),d(t−1), . . . , d(0)) is the binary representation of d, where d(t) is the most significant bit and d(0) is the least significant bit. The algorithm returns as output the element y=gˆd in the group G.

The left-to-right binary exponentiation algorithm comprises the following three steps:
1) Initialize the register A with the neutral element G
2) For i from t down to 0, do the following:
   2a) Replace A with Aˆ2
   2b) If d(i)=1, then replace A with A·g
3) Return A.

The left-to-right k-ary exponentiation algorithm takes as input an element g of a group G and an exponent d noted d=(d(t),d(t−1), . . . , d(0)), where (d(t),d(t−1), . . . , d(0)) is the k-ary representation of d, i.e. each digit d(i) of the representation of d is an integer lying in the range 0 to 2ˆk−1 for an integer k≧1, where d(t) is the most significant digit and d(0) is the least significant digit. The algorithm returns as output the element y=gˆd in the group G and comprises the following four steps:
1) Precomputation:
   (1a) Let g₁=g
   (1b) If k≧2, for i from 2 to (2ˆk−1): compute gᵢ=dˆi
2) Initialize the register A with the neutral element G
(3) For i from t down to 0, do the following:
   (3a) Replace A with Aˆ(2ˆk)
   (3b) If d(i) is non-zero, replace A with A·gᵢ
4) Return A.

When k is equal to 1, it is observed that the left-to-right k-ary exponentiation algorithm is none other than the left-to-right binary exponentiation algorithm.

The left-to-right k-ary exponentiation algorithm can be adapted to take as input a signed-digit representation of the exponent d. The exponent d is given by the k-ary signed-digit representation (d(t),d(t−1), . . . , d(0)) in which each digit (d(i) is an integer lying in the range −(2ˆk−1) to 2ˆk−1 for an integer k≧1, where d(t) is the most significant digit and d(0) is the least significant digit. Step 3b of the preceding algorithm is then replaced with:
3b′) If d(i) is strictly positive, replace A with A·gᵢ; and if d(i) is strictly negative, replace A with A·(gᵢ) ˆ(−1).

That adaptation is particularly advantageous when the inverses of the elements gᵢ, written (gᵢ) ˆ(−1), are easy or low-cost to compute. This applies, for example, in the group G of the points of an elliptic curve. When the inverses of the elements gᵢ are not easy or are too costly to compute, their values are precomputed.

In certain situations, the product of two exponentiations, of the type (gˆg)·(hˆe) in a group G where g and h are elements of G, and d and e are two integers whose binary representations are respectively (d(t),d(t−1), . . . , d(0)) and (e(t),e(t−1), . . . , e(0)), are to be computed. This applies in particular to a Digital Signature Algorithm (DSA) digital signature. Rather than computing each exponentiation gˆd and hˆe separately and then evaluating the product thereof, the left-to-right binary exponentiation algorithm can extend to compute the double exponentiation (gˆd)·(hˆe) in G as follows:
1) Initialize the register A with the neutral element G
2) For i from t down to 0, do the following:
   2a) Replace A with Aˆ2
   2b) If d(i)=1, replace A with A·g
   2c) If e(i)=1, replace A with A·h
3) Return A.

The advantage of that method is that the number of multiplications for the computation of (gˆd)·(hˆe) is small compared with two successive applications of the left-to-right binary exponentiation algorithm. An improvement in speed for the preceding algorithm consists in precomputing the element u=g·h in G. Thus, the double binary exponentiation algorithm for computing (gˆd)·(hˆe) in G can be written:
1) Precomputation:
   1a) Compute u=g·h
2) Initialize the register A with the neutral element of G
3) For i from t down to 0, do the following:
   3a) Replace A with Aˆ2
   3b) If d(i)=1 and e(i)=0, replace A with A·g
   3c) If d(i)=0 and e(i)=1, replace A with A·h
   3c) If d(i)=1 and e(i)=1, replace A with A·u
4) Return A.

The preceding double binary exponentiation algorithm can be generalized by taking as input elements g and h of a group G and exponents d and e given respectively by the k-ary representations d=(d(t),d(t−1), . . . , d(0)) and e=(e(t),e(t−1), . . . , e(0)), for an integer k≧1. The algorithm returns as output the element y=(gˆd)·(hˆe) in the group G and comprises the following four steps:
1) Precomputation:
   1a) Let g₁=g and h₁=h
   1b) If k≧2, for i from 2 to (2ˆk−1): compute gᵢ=gˆi and hᵢ=hˆi
   2) Initialize the register A with the neutral element G
3) For i from t down to 0, do the following:
   3a) Replace A with Aˆ(2ˆk)
   3b) If d(i) is non-zero, replace A with A·gᵢ
   3c) If e(i) is non-zero, replace A with A·hᵢ
4) Return A.

If the exponents e and d are given as k-ary representation signed by d=(d(t),d(t−1), . . . , d(0)) and e=(e(t),e(t−1), . . . , e(0), steps 3b and 3c of the preceding algorithm are then replaced with:
3b′) If d(i) is strictly positive, replace A with A·gᵢ; and if d(i) is strictly negative, replace A with A·(gᵢ) ˆ(−1)
3c′) If e(i) is strictly positive, replace A with A·hᵢ; and if e(i) is strictly negative, replace A with A·(hᵢ) ˆ(−1)

Remarkably, the double exponentiation algorithm corresponding to the case k=1 in the preceding algorithm in which the exponents d and e are given as binary signed-digit representations is particularly advantageous for applications of the elliptic curve type in an environment of the smart card type because the inverse of an element is low-cost and the memory needs are small. Numerous variants on this particular case of k=1 are presented in a technical report by Jerome Solinas (Technical Report CORR-2001-41, Center for Applied Cryptographic Research (CACR), University of Waterloo, Canada).

This list of double exponentiation algorithms is not exhaustive.

The above-described exponentiation and double exponentiation algorithms are given in multiplicative notation; in other words the group law of the group G is written “.” (multiplication). Those algorithms can be given in additive notation by replacing the multiplications with additions; in other words, the group law of the group G is written “+” (addition). This applies, for example, for the group of the points of an elliptic curve which is usually given in additive form.

It has appeared that, on a smart card, implementing a public-key cryptography algorithm built on a group G is vulnerable to attacks consisting in differentially analyzing a physical magnitude making it possible to retrieve the secret key. Such attacks are known as “Differential Power Analysis” (“DPA”) attacks and they were revealed in particular by Paul Kocher (Advances in Cryptology—CRYPTO '99, volume 1966 of Lecture Notes in Computer Science, pages 388-397, Springer-Verlag, 1999). Among the physical magnitudes that can be used for such purposes, mention can be made of current consumption, electromagnetic field, etc. Such attacks are based on the fact that handling a bit, i.e. processing a bit by means of a particular instruction, has a particular imprint on the physical magnitude in question, depending on its value.

In particular, when an instruction handles data having a particular bit that is constant, with it being possible for the values of the other bits to vary, analysis of current consumption due to the instruction shows that the mean consumption of the instruction is not the same depending on whether the particular bit takes the value 0 or 1. A DPA-type attack thus makes it possible to obtain additional information on the intermediate data handled by the microprocessor of the electronic component during execution of a cryptography algorithm. Said additional information can, in certain cases, make it possible to reveal private parameters of the cryptography algorithm, making the cryptographic system vulnerable.

An effective parry to attacks of the DPA type is to make the inputs of the exponentiation algorithm used to compute y=g d random. In other words, the exponent d and/or the element g is/are made random. In additive notation, in the computation of Q=d*P, the exponent d and/or the element P is/are made random.

Countermeasure methods applying that principle are known.

In particular, a countermeasure method consists in masking the exponent d in the computation of y=gˆd in a group G by replacing d with d+r·q, where r is a random integer and q is a multiple of the order of the element g in the group G; by using Lagrange's theorem, a common choice for that multiple is the order of the group G. The value of y=gˆd in G is then obtained by computing y=gˆd′ with d′=d+r·q. That countermeasure is, in particular, described in an article by Jean-Sabastien Coron (Cryptographic Hardware and Embedded Systems, volume 1717 of Lecture Notes in Computer Science, pages 292-302, Springer-Verlag, 1999) when G is the group of the points of an elliptic curve defined on a finite field.

The disadvantage of the preceding countermeasure is that it requires knowledge of the order of the element g in the group G or of a multiple of that order. In many situations, that value is unknown and too costly or impossible to compute. Another disadvantage appears when the exponent d is replaced with d+r·q where q is a relatively large multiple of the order of the element g in the group G because the extra cost generated by the masking becomes prohibitive.

Another countermeasure method described, in particular, in an article by Christophe Clavier and Marc Joye (Cryptographic Hardware and Embedded Systems, volume 2162 of Lecture Notes in Computer Science, pages 300-308, Springer-Verlag, 2001) consists in writing the exponent d in the form d=(d−r)+r, where r is a random integer, and then in evaluating y=gad in the group G as the product of the two exponentiations gˆ(d−r) and gˆr in G. Unlike the countermeasure described above, that countermeasure does not require the value of the order of g in G or of one of its multiples. A variant consists in drawing a random integer r and in writing d in the form d=d₂·r+d₁, where d₂ is equal to the default value of the integer division of d by r, and r₁ is equal to the remainder of said division. The computation of y=gˆd in the group G is then evaluated as the product of the two exponentiations gˆd₁ and hˆd₂, where h=gˆr in G. The disadvantage with that type of countermeasure is that a plurality of exponentiations are necessary for computing y=gˆd in G.

An object of the present invention is to provide a countermeasure method, in particular for implementing a countermeasure against DPA-type attacks.

Another object of the invention is to provide a countermeasure method that is easy to implement.

The basic idea of the invention is to make the exponent d random by expressing it randomly in the form d=d₂·s+d₁, where d₁, d₂, and s are integers, and then by computing the exponentiation y=gˆd in the group G by using a double exponentiation algorithm.

The invention thus provides a countermeasure method for implementation in an electronic component and implementing a public-key cryptography algorithm comprising exponentiation computation of the type y=gˆd, where g and y are elements of the determined group G written in multiplicative notation, and d is a predetermined number, said countermeasure method being characterized in that it comprises a masking first step for expressing the exponent d randomly in the form d=d₂·s+d₁, where d₁, d₂, and s are integers and a second step for computing the value of y=gˆd in G by any double exponentiation algorithm of the type (gˆd₁)·(hˆd₂) with h=g's in G. This method applies in the same way if the group G is written in additive notation.

Other characteristics and advantages of the invention are presented in the following descriptions, given with reference to particular implementations.

It is explained above that the simplest exponentiation algorithm in a group G is the left-to-right exponentiation algorithm. In the same way, the simplest double exponentiation algorithms are given by the various extensions of the left-to-right binary exponentiation algorithm.

Let g be an element of a group G, and let d be an exponent. Thus, a countermeasure method of the invention can be written as follows:

1) Masking of d:
1a) Express d randomly in the form d=d₂·s+d₁, where d₁, d₂, and s are integers
   1b) Let (d₁(t),d₁(t−1), . . . , d₁(0)) and (d₂(t),d₂(t−1), . . . , d₂(0)) be the respective binary representations of d₁ and of d₂

2) Double exponentiation:
2a) Define (compute) the element h=gˆs in G
2b) Initialize the register A with the neutral element of G
2c) For i from t down to 0, do the following:
   2c1) Replace A with Aˆ2
   2c2) If d₁(i)=1, replace A with A·g P2 2c3) If d₂(i)=1, replace A with A·h
   2c4) Return A.

Remarkably, this method masks the exponent d and requires at the most only three multiplications in G per iteration at step 2). This number of multiplications in G is reduced to two when the product of g and of h is precomputed. The following countermeasure method is thus obtained:

1) Masking of d:
1a) Express d randomly in the form d=d₂·s+d₁, where d₁, d₂, and s are integers
   1b) Let (d₁(t),d₁(t−1), . . . , d₁(0)) and (d₂(t),d₂(t−1), . . . , d₂(0)) be the respective binary representations of d₁ and of d₂

2) Double exponentiation:
2a) Define (compute) the element h=gˆs in G
2b) Precompute u=g·h in G
2c) Initialize the register A with the neutral element of G
2d) For i from t down to 0, do the following:
   2d1) Replace A with Aˆ2
   2d2) If d₁(i)=1 and d₂(i)=0, replace A with A·g
   2d3) If d₁(i)=0 and d₂(i)=1, replace A with A·h
   2d4) If d₁(i)=1 and d₂(i)=1, replace A with A·u
   2d5) Return A.

Another advantageous application of the invention concerns the exponentiation in the group G of the points of an elliptic curve defined on a finite field GF(qˆn). In said group G, written in additive notation, the inversion of a point P, written -P, is an operation that is low-cost so that it is advantageous to represent the exponents in signed-digit manner. Let P be a point in the group G of the points of an elliptic curve defined on a finite field GF(qˆn) and let d be an exponent. Thus, a countermeasure method of the invention applied to the group of points of an elliptic curve on a finite field GF(qˆn) can be written as follows:

1) Masking of d:
1a) Express d randomly in the form d=d₂·s+d₁, where d₁, d₂, and s are integers
   1b) Let (d₁(t),d₁(t−1), . . . , d(0)) and (d₂(t),d₂(t−1), . . . , d₂(0)) be the respective binary signed-digit representations for d₁ and for d₂

2) Exponentiation:
2a) Define (compute) the point R=s*P in G
2b) Initialize a register A with the neutral element of G
2c) For i from t down to 0, do the following:
   2c1) Replace A with 2*A
   2c2) If d₁(i) is non-zero, replace A with A+d₁(i)*P
   2c3) If d₂(i) is non-zero, replace A with A+d₂(i)*R
   2c4) Return A.

In general, the countermeasure method applies to any double exponentiation algorithm in a group G, written in multiplicative notation or in additive notation.

A preferred implementation for expressing the exponent d randomly in the form d=d₂·s+d₁, where d₁, d₂, and s are integers at step 1a in the above countermeasure methods consists in choosing a random integer s, and in taking d₂ equal to the default value of the integer division of d by s, and d₁ equal to the remainder of said division.

Another preferred implementation for expressing the exponent d randomly in the form d=d₂·s+d₁, where d₁, d₂, and s are integers at step 1a in the above countermeasure methods consists in choosing a random integer d₁, in setting s to the value 1 and in taking d₂ equal to the difference between d and d₁.

1. A countermeasure method performed in an electronic component and implementing a public-key cryptography algorithm utilizing exponentiation computation of the type y=gˆd, where g and y are elements of a determined group G written in multiplicative notation, and d is a predetermined number, said countermeasure method comprising a masking first step for expressing the exponent d randomly in the form d=d₂·s+d₁, where d₁, d₂, and s are integers, and a second step for computing the value of y=gˆd in G by any double exponentiation algorithm of the type (gˆd₁)·(hˆd₂) with h=gˆs in G.

2. A countermeasure method according to claim 1, wherein the group G is written in additive notation.

3. A countermeasure method according to claim 1, wherein the method comprises the following steps:
1) Masking of d:
1a) Express d randomly in the form d=d₂·s+d₁, where d₁, d₂, and s are integers
1b) Let (d₁(t),d₁(t−1), . . . , d₁(0)) and (d₂(t),d₂(t−1), . . . , d₂(0)) be the respective binary representations of d₁ and of d₂
2) Double exponentiation:
2a) Define (compute) the element h=gˆs in G
2b) Initialize the register A with the neutral element of G
2c) For i from t down to 0, do the following:
2c1) Replace A with Aˆ2
2c2) If d₁(i)=1, replace A with A·g
2c3) If d₂(i)=1, replace A with A·h
2c4) Return A.

4. A countermeasure method according to claim 1, wherein the method comprises the following steps:
1) Masking of d:
1a) Express d randomly in the form d=d₂·s+d₁, where d₁, d₂, and s are integers
1b) Let (d₁(t),d₁(t−1), . . . , d₁(0)) and (d₂(t),d₂(t−1), . . . , d₂(0)) be the respective binary representations of d₁ and of d₂
2) Double exponentiation:
2a) Define (compute) the element h=gˆs in G
2b) Precompute u=g·h in G
2c) Initialize the register A with the neutral element of G
2d) For i from t down to 0, do the following:
2d1) Replace A with Aˆ2
2d2) If d₁(i)=1 and d₂(i)=0, replace A with A·g
2d3) If d₁(i)=0 and d₂(i)=1, replace A with A·h
2d4) If d₁(i)=1 and d₂(i)=1, replace A with A·u
2d5) Return A.

5. A countermeasure method according to claim 2, wherein the method comprises the following steps:
1) Masking of d:
1a) Express d randomly in the form d=d₂·s+d₁, where d₁, d₂, and s are integers
1b) Let (d₁(t),d₁(t−1), . . . ,d₁(0)) and (d₂(t),d₂(t−1), . . . ,d₂(0)) be the respective binary signed-digit representations for d₁ and for d₂
2) Exponentiation:
2a) Define (compute) the point R=s*P in G
2b) Initialize a register A with the neutral element of G
2c) For i from t down to 0, do the following:
2c1) Replace A with 2*A
2c2) If d₁(i) is non-zero, replace A with A+d₁(i)*P
2c3) If d₂(i) is non-zero, replace A with A+d₂(i)*R
2c4) Return A.

6. A countermeasure method according to claim 1, wherein the step of expressing the exponent d randomly in the form d=d₂·s+d₁, where d₁, d₂, and s are integers, comprises choosing a random integer s and taking d₂ equal to the default value of the integer division of d by s, and d₁ equal to the remainder of said division.

7. A countermeasure method according to claim 1, wherein the step of expressing the exponent d randomly in the form d=d₂·s+d₁, where d₁, d₂, and s are integers, comprises choosing a random integer d₁, setting s to the value 1, and taking d₂ equal to the difference between d and d₁.

8. An electronic component implementing the method according to claim 1.

9. A countermeasure method according to claim 2, wherein the step of expressing the exponent d randomly in the form d=d₂·s+d₁, where d₁, d₂, and s are integers, comprises choosing a random integer s and taking d₂ equal to the default value of the integer division of d by s, and d₁ equal to the remainder of said division.

10. A countermeasure method according to claim 3, wherein the step of expressing the exponent d randomly in the form d=d₂·s+d₁, where d₁, d₂, and s are integers, comprises choosing a random integer s and taking d₂ equal to the default value of the integer division of d by s, and d₁ equal to the remainder of said division.

11. A countermeasure method according to claim 4, wherein the step of expressing the exponent d randomly in the form d=d₂·s+d₁, where d₁, d₂, and s are integers, comprises choosing a random integer s and taking d₂ equal to the default value of the integer division of d by s, and d₁ equal to the remainder of said division.

12. A countermeasure method according to claim 5, wherein the step of expressing the exponent d randomly in the form d=d₂·s+d₁, where d₁, d₂, and s are integers, comprises choosing a random integer s and taking d₂ equal to the default value of the integer division of d by s, and d₁ equal to the remainder of said division.

13. A countermeasure method according to claim 2, wherein the step of expressing the exponent d randomly in the form d=d₂·s+d₁, where d₁, d₂, and s are integers, comprises choosing a random integer d₁, setting s to the value 1, and taking d₂ equal to the difference between d and d₁.

14. A countermeasure method according to claim 3 wherein the step of expressing the exponent d randomly in the form d=d₂·s+d₁, where d₁, d₂, and s are integers, comprises choosing a random integer d₁, setting s to the value 1, and taking d₂ equal to the difference between d and d₁.

15. A countermeasure method according to claim 4, wherein the step of expressing the exponent d randomly in the form d=d₂·s+d₁, where d₁, d₂, and s are integers, comprises choosing a random integer d₁, setting s to the value 1, and taking d₂ equal to the difference between d and d₁.

16. A countermeasure method according to claim 5, wherein the step of expressing the exponent d randomly in the form d=d₂·s+d₁, where d₁, d₂, and s are integers, comprises choosing a random integer d₁, setting s to the value 1, and taking d₂ equal to the difference between d and d₁.

17. A countermeasure method according to claim 6, wherein the step of expressing the exponent d randomly in the form d=d₂·s+d₁, where d₁, d₂, and s are integers, comprises choosing a random integer d₁, setting s to the value 1, and taking d₂ equal to the difference between d and d₁.

18. An electronic component implementing the method according to claim 2.

19. An electronic component implementing the method according to claim 3.

20. An electronic component implementing the method according to claim 4.
